(19) United States
(12) Patent Application Publication
(10) Pub. No.: US 2003/0161936 A1
(43) Pub. Date: Aug. 28, 2003

(54) Process for preparing crabmeat appetizers

(76) Inventors: Barry L. Johnston, St. Simons Island, GA (US); William S. Sullins, St. Simons Island, GA (US)

Correspondence Address: Donald C. Casey, Suite 100, 311 North Washington Street, Alexandria, VA, 22314, US

(21) Appl. No.: 10/082,302

(22) Filed: Feb. 26, 2002

(51) Int. Cl. A23L 1/325

(52) U.S. Cl. 426/643

(57) ABSTRACT

A process for preparing a hand held appetizer of crabmeat is described. In the process, paddle legs or claws are removed from crabs and dusted with an edible dust. Crabmeat is mixed with a binder, and hand formed around the end of each leg. The composite leg with crabmeat attached is then dusted again with the edible dust, covered with batter and breadcrumbs and fried for a few seconds until it turns golden brown. The composites are then frozen for commercial distribution.

### FIELD OF THE INVENTION

This invention relates to a process for preparing appetizers consisting of crabmeat for commercial distribution, and in particular to a process for preparing appetizers consisting of crab legs with additional meat attached for distribution as frozen pre-fried appetizer.

### DESCRIPTION OF THE PRIOR ART

The blue swimming crab (species: Portunus pelagicus) is well known for its succulent meat and well known for the difficulty attached to picking that meat from the shell after cooking. In contrast to the king crab, the claws and swimmers constituting the legs of the these crabs contain a relatively small amount of meat with the bulk of the crabmeat contained within the shell body of the crab. In fact, in picking such a crab the swimmers or paddle legs would normally be discarded. The meat within the claw would also only be available after cracking the claw, but the cracking process can mash the meat and leave shell bits embedded in the meat. Accordingly, such crab legs are not known for use as appetizers.

In U.S. Pat. No. 3,135,992 there is a machine described for harvesting meat from the claws of king crabs. A large chunk of meat is contained within the bulb between the last hinge of the leg and the claw hinge. In that patent, the claw is bisected by cutting the shell longitudinally whereby the claw portion integral with the shell is separated from the hinged portion identified as the pollex and the chunk of meat remains integral with the horn or pollex extending therefrom as a handle. As is well known, the claws of king crabs are substantially larger than those of the blue swimming crab and therefrom even if this machine could be adapted to bisect the claw of a blue swimming crab the exposed meat would be only a small amount.

It has been proposed, for example, in U.S. Pat. No. 5,431,938 to make a composite of shrimp whereby smaller shrimp are stacked to form a composite which is coated and batter fried to form a product having the look of a large individual shrimp. In that process, the shrimp composites are dusted and frozen in individual molds, and then coated with batter and deep fried.

It is also known to prepare a molded seafood product wherein seafood is milled to form a paste. See, for example, U.S. Pat. Nos. 4,820,529 and 4,889,742. This type of fish meat product may or may not contain crabmeat or meat from any crustacean source. This type of product is generally known as surimi in the trade.

Accordingly, there is a need to produce an edible product from blue swimming crabs which consists entirely of crabmeat, utilizes the legs of the crab, and is relatively easy to serve and eat.

### SUMMARY OF THE INVENTION

It has been discovered that the hinged crab claw portion with the bulb removed, and the swimmer or paddle leg can be crowned with crabmeat battered, pre-fried and frozen for commercial distribution as a hand-held appetizer wherein the shell portion remaining on the leg serves as a handle. The crown will be retained thereon so that it can be dipped in an appetizer sauce or eaten directly.

It is an object of this invention then to provide a process for preparing a crabmeat appetizer consisting entirely of crabmeat wherein the crab leg portion is used as a handle to mount a crown or cap of crabmeat.

It is another object of this invention to provide a pre-fried battered crabmeat appetizer which can be defrosted and heated to serve wherein the portion of the shell is retained as a handle to mount the pre-fried crabmeat appetizer.

It is still another object of this invention to provide a food product utilizing the legs of blue swimming crabs as handles to mount crabmeat wherein the resulting product provides a bite sized battered appetizer and wherein the count of said appetizers is about 21-25 per pound of product.

These and other objects will become readily apparent with reference to the drawings and following description wherein:

### BRIEF DESCRIPTION OF THE DRAWINGS

FIG. 1a is a perspective view of a crab claw having the bulb shell removed prior to crowning with crabmeat.

FIG. 1b is a perspective view of the product of FIG. 1a having the crown applied according to the process of this invention.

FIG. 2a is perspective view of a crab swimmer leg or paddle prior to crowning.

FIG. 2b is a perspective view of the swimmer of FIG. 2a having the crown of crabmeat applied according to the process of this invention.

### DETAILED DESCRIPTION OF THE INVENTION

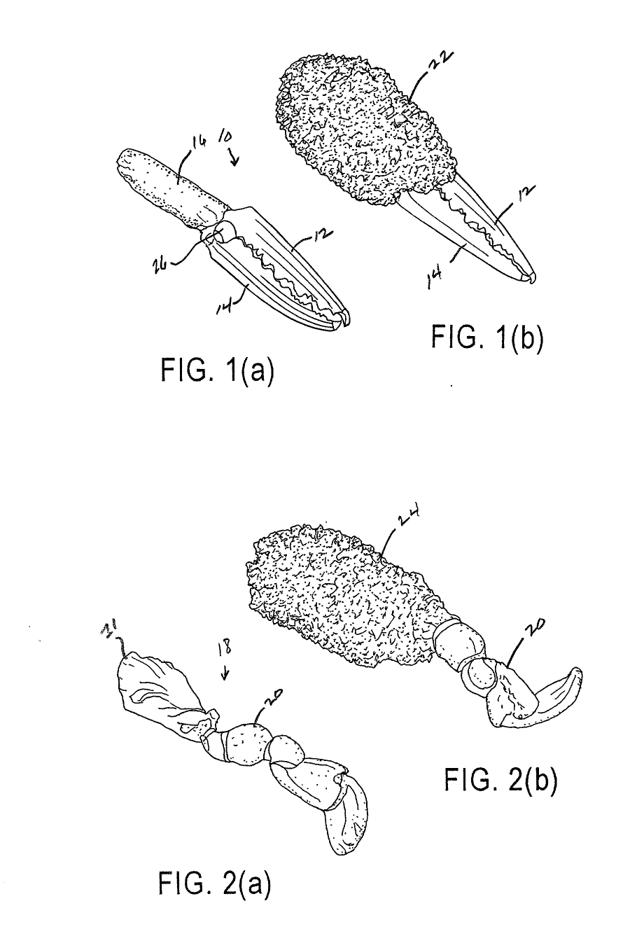

With attention to the drawings, FIG. 1a shows a portion of a two pincher crab claw 10 wherein the bulb (not shown) located behind the pinchers 12 and 14 has been removed to expose meat and membrane 16 which is integral with the small portion of meat within the pollex 12. The bulb which would surround the meat and membrane 16 is that portion of shell which extends from the last joint to the claw portion 12 and 14.

FIG. 2a shows a crab paddle or swimmeret commonly referred to as a swimmer leg 18 which has an articulated shell 20 which extends from the membrane portion 21 which would in turn be attached to the body shell by the membrane. Elements 10 and 18 are normally removed when picking the crab by hand by merely twisting the individual legs 10 and 18 until the membrane connecting the leg shell to the body shell is severed.

FIG. 1b shows the finished item wherein a crown of crabmeat 22 has been affixed to the pinchers 12 and 14 and FIG. 2b shows a similar arrangement with a crown 24 affixed to the leg 20.

In the case of FIG. 1b, the crown covers the meat and membrane portion 16 and the hinge portion 26 so that the pinchers 12 and 14 serve as a handle.

In the case of FIG. 2b, the crown 24 covers the membrane portion 21 and a portion of the shell 20 of the leg 18 so that the remaining portion of the shell 20 extending from the crown 24 serves as a handle.

In order to formulate the product of FIG. 1b or 2b in general, crabmeat is mixed with a binder and the claw portion of FIG. 1a or 2a is dusted to facilitate binding of the crabmeat. The crown 22 or 24 is then formed by hand on the shell portion 10 or 18. The product is then predusted, battered, breaded, par-fried, chilled, and then frozen.

The following examples are not intended to be limitative of the invention but rather to described preferred embodiments.

### EXAMPLE 1

In order to form the product of FIG. 1b the crab preferably is wild-caught, the crab claw and meat inspected and chilled to below about 50° F. The excess shell surrounding the meat and membrane portion 16 is then removed and the remaining portion packed in a plastic wrap and chilled in an ice tank where it is maintained at less than about 50° F.

Meanwhile crabmeat is mixed with dehydrated egg white powder, breadcrumbs, guar gum and water. It should be noted that guar gum is only an example. Any water-soluble gum may be used in the alternative such as xanthan gum, sodium alginate, and locust bean gum. The crab claw of FIG. 1a is then dusted with a pre-dust. The pre-dust preferable is a modified tapioca starch with salt and rice flour wherein the starch is present in from 90 to 96% by weight, salt 2-4% by weight, and rice flour 2-6% by weight. This is to facilitate binding of the crabmeat to the shell. The crabmeat mixture is then formed around the crab claw to the article shown in FIG. 1b and the resulting composite dusted with about identified pre-dust.

A batter is then prepared of unbleached wheat flour, salt, vegetable shortening (preferably partially hydrogenated palm oil), guar gum, dextrose and leavening such as sodium bicarbonate, sodium acid pyrophosphate and calcium phosphate. The flour is present in about 88-93% by weight, salt 2-3%, vegetable shortening 2-3%, guar gum 1-2%, dextrose 1-2%, and leavening 1-2%. The batter is hydrated in a ration of about 1:4 (dry:cool water). The pre-dusted article then is dipped into the batter. A resulting product is then dredged through Japanese breadcrumbs with a light pressure applied to press the breadcrumbs into the surface of the article.

The breadcrumb formulation in a preferred embodiment consists of 87-92% unbleached wheat flour, 3-5% shortening (partially hydrogenated palm oil), 2-3% salt, 2-3% sugar, 0.1-0.3% yeast and 1-2% soybean meal.

The resulting breaded product is then par-fried in soybean oil at about 302-320° F. for 65seconds to achieve a light golden brown color. The core temperature of the product would be approximately 162° F.

The product is then chilled to less than 50° F. and then frozen to a core temperature of −0.4° F. The frozen product is then packed into a carton for shipment and maintained in a cold storage freezer at about −0.4° F.

As noted above, the resulting product may be categorized as between 21 and 25 pieces per pound. The product is about 70-80% crab claw meat, 15-25% water, 4-5% dehydrated egg white powder, 1-3% breadcrumbs and 0.1-0.3% guar gum.

### EXAMPLE 2

In order to form the product of FIG. 2b the crab paddle 18 is removed from harvested crabs and chilled. As in Example 1, crabmeat is mixed with dehydrated egg white powder, guar gum and water and the leg portion 18 is dusted with the pre-dust. The crabmeat combination with binder is then formed by hand around the handle portion 20 to form the product of FIG. 2b. The product is then coated with pre-dust and battered as described about relative to Example 1. Japanese breadcrumbs are then applied in the same manner as described above, and the swimmer is par-fried in partially hydrogenated soybean oil at about 302-320° F. for 65 seconds to achieve the light golden brown color with a core temperature of approximately 162° F. The product is then chilled to below 50° F. and subsequently frozen to a core temperature of −0.4° F. The product is then packaged and transferred to a cold storage freezer.

The resulting crab swimmer product of FIG. 2b has a lump crabmeat concentration of 70-80%, water 20-30%, dehydrated egg white powder 4-5%, breadcrumbs 2-3% and guar gum 0.1-0.3%.

The resulting products of FIGS. 1b and 2b then are marketed as pre-fried golden brown frozen appetizers which may be defrosted and heated for serving. A variety of appetizer sauces may then be used with the leg portion 20 or pinchers 12 and 14 serving as a handle wherein to dip the crown 22 or 24 into the sauce for consumption.

It will be readily seen by one of ordinary skill in the art that the present invention fulfills all of the objects set forth above. After reading the foregoing specification, one of ordinary skill will be able to effect various changes, substitutions or equivalents and various other aspects of the invention as broadly disclosed herein. It is therefore intended that the protection granted hereon be limited only by the definition contained in the appended claims and equivalents thereof.

1. Method of preparing a crabmeat appetizer using crab legs from blue swimming crabs comprising:
providing a plurality crabs and removing the legs from the body shell to form legs having a shell at one end and connecting membrane at an opposite end;
dusting said legs with an edible powder;
providing a supply of crabmeat and mixing said meat with an egg powder binder;
molding a lump of said crabmeat and binder around the membrane end of each leg to form a composite and dusting each composite with said edible powder;
coating each composite with batter and then with breadcrumbs; and
frying each battered composite until it is golden brown.

2. The method of claim 1 wherein the shell end of each leg is the hinged pincher.

3. The method of claim 1 wherein each leg is a paddle leg.

4. The method of claim 1 further comprising freezing each composite after frying.

5. The method of claim 4 wherein each composite is frozen to a core temperature of about −0.4° F.

6. The method of claim 1 wherein said battered composites are fried at a temperature of about 302-320° F. for about 65 seconds.

7. The method of claim 6 wherein the core temperature after frying is about 162° F.

8. The method of claim 1 wherein said dust is a modified tapioca starch.

9. The method of claim 1 wherein said batter contains unbleached wheat flour, a water soluble gum, vegetable shortening, dextrose and leavening.

10. The method of claim 1 wherein said breadcrumbs includes wheat flour and soybean meal.
